(19) United States
(12) Patent Application Publication
(10) Pub. No.: US 2016/0326781 A1
(43) Pub. Date: Nov. 10, 2016

(54) RECEIVER LOCK

(71) Applicant: Connor USA LLC, Oceanside, NY (US)

(72) Inventors: Shu Zhen CHEN, Westbury, NY (US); Henry CHEN, Westbury, NY (US)

(73) Assignee: CONNOR USA LLC

(21) Appl. No.: 14/705,283

(22) Filed: May 6, 2015

(51) Int. Cl. E05B 85/06; B60R 11/00; E05B 77/00

(52) U.S. Cl. CPC E05B 85/06; E05B 77/00; B60R 11/00; B60R 2011/004; B60R 2011/0061

(57) ABSTRACT

A receiver lock is provided. The receiver lock includes a lock rod having a distal portion configured to extend through aligned apertures of an insert and an accessory receiver to prevent removal of the insert from the accessory receiver. The distal portion includes an annular groove adjacent a distal end of the distal portion. A lock assembly includes a lock housing that is configured to receive the distal portion of the lock rod such that reception of the distal portion within the lock housing triggers a lock mechanism of the lock housing to automatically engage the annular groove of the distal portion for locking the lock rod to the lock assembly.

### BACKGROUND OF THE INVENTION

1. Field of the Invention

The present invention relates generally to a receiver lock, and more particularly, to a receiver lock that includes a lock assembly including an automatic locking mechanism and an automatic ejection mechanism.

2. Description of the Related Art

Historically, hitches mounted to a towing vehicle included fixed components permanently secured to the vehicle. A hitch body was bolted or welded to the vehicle and included a hitch ball fixed to the hitch body. As hitch manufacturers developed more uses for their hitches, the fixed ball was replaced by a removable ball insert received within a receiver forming a part of the hitch body. Both the insert and receiver had a rectangular configuration such that the receiver would matingly receive the insert. To prevent inadvertent removal of the receiver, a lock rod (or pin) inserted transversely through the insert and receiver mated the components. The insert could be conveniently removed for interchange to a different insert associated with an accessory such as a cargo platform, bike carrier, ski rack, etc. However, this freedom to interchange accessories also lended them to theft since removal was as simple as removing a pin.

In order to prevent removal of the lock rod and therefore unauthorized removal of any hitch accessory, various locking methods were developed. A lock secured to the lock rod was first developed which prevented withdrawal of the lock rod without first removing the lock.

These add-on locks proved cumbersome to use and were subjected to the elements of the road along with the rest of the undercarriage.

Specialized lock rods incorporating a locking mechanism were developed which allowed the user to replace the lock rod with a receiver lock. However, many of these receiver locks were inconvenient to use and subject to failure because of the intricate parts used for the locking mechanisms.

### SUMMARY OF THE INVENTION

The present invention has been made to address the above problems and disadvantages, and to provide at least the advantages described below.

In accordance with an aspect of the present invention, there is provided a receiver lock that is configured to lockingly connect an accessory insert within a receiver of a vehicle hitch assembly. The receiver and accessory insert include alignable apertures. The receiver lock includes a lock rod having a distal portion configured to extend through the aligned apertures of the insert and accessory receiver to prevent removal of the insert from the accessory receiver.

The distal portion includes an annular groove adjacent a distal end of the distal portion. A lock assembly includes a lock housing that is configured to receive the distal portion of the lock rod such that reception of the distal portion within the lock housing triggers a lock mechanism of the lock housing to automatically engage the annular groove of the distal portion for locking the lock rod to the lock assembly.

In accordance with another aspect of the present invention, there is provided a lock assembly that is configured to detachably mount to a lock rod configured to lockingly connect an accessory insert within a receiver of a vehicle hitch assembly. The receiver and accessory insert includes alignable apertures. The lock assembly includes a lock housing that is configured to receive a distal portion of the lock rod such that reception of the distal portion within the lock housing triggers a lock mechanism of the lock housing to automatically engage an annular groove of the distal portion for locking the lock rod to the lock assembly.

In accordance with another aspect of the present invention, there is provided a receiver lock that is configured to lockingly connect an accessory insert within a receiver of a vehicle hitch assembly. The receiver and accessory insert include alignable apertures. The receiver lock includes a lock rod having a distal portion configured to extend through the aligned apertures of the insert and accessory receiver to prevent removal of the insert from the accessory receiver. A lock assembly includes a lock housing, and insertion of the distal portion of the lock rod into the lock housing moves a spring head of the lock assembly proximally against a bias of a spring thereby moving a cylinder of the lock assembly from an unlocked configuration for receiving the distal portion of the lock rod to a locked configuration for automatically locking the lock rod to the lock assembly.

In accordance with another aspect of the present invention, there is provided a lock assembly configured to detachably mount to a lock rod configured to lockingly connect an accessory insert within a receiver of a vehicle hitch assembly. The receiver and accessory insert include alignable apertures. The lock assembly includes a lock housing and a cylinder, wherein insertion of a distal portion of the lock rod into the lock housing moves a spring head of the lock assembly proximally against a bias of a spring thereby moving the cylinder of the lock assembly from an unlocked configuration for receiving the distal portion of the lock rod to a locked configuration for automatically locking the lock rod to the lock assembly.

In accordance with another aspect of the present invention, there is provided a receiver lock configured to lockingly connect an accessory insert within a receiver of a vehicle hitch assembly. The receiver and accessory insert include alignable apertures. The receiver lock includes a lock rod having a distal portion configured to extend through the aligned apertures of the insert and accessory receiver to prevent removal of the insert from the accessory receiver. A lock assembly includes a lock housing, wherein, with the lock rod locked to the lock housing, rotation of a cylinder of the lock assembly releases a spring head of the lock assembly such that the spring head is urged distally under a force provided by spring connected to the spring head thereby automatically ejecting the lock rod from the lock assembly.

In accordance with another aspect of the present invention, there is provided a lock assembly configured to detachably mount to a lock rod configured to lockingly connect an accessory insert within a receiver of a vehicle hitch assembly. The receiver and accessory insert include alignable apertures. The lock assembly includes a lock housing and a cylinder, wherein, with the lock rod locked to the lock housing, rotation of a cylinder of the lock assembly releases a spring head of the lock assembly such that the spring head is urged distally under a force provided by spring connected to the spring head thereby automatically ejecting the lock rod from the lock assembly.

### BRIEF DESCRIPTION OF THE DRAWINGS

The above and other aspects, features, and advantages of certain embodiments of the present invention will be more apparent from the following detailed description taken in conjunction with the accompanying drawings, in which:

FIG. 1 is a perspective view of a receiver lock including a lock assembly and a lock rod, which are shown unattached, according to an embodiment of the present invention;

FIG. 2 is a perspective view of the lock assembly shown in FIG. 1, with parts separated, according to an embodiment of the present invention;

FIG. 3A is a partial cross-sectional view of the lock assembly shown in FIG. 2, with the lock assembly shown in a locked configuration, according to an embodiment of the present invention;

FIG. 3B is rear end view of the lock assembly shown in FIG. 3A, according to an embodiment of the present invention;

FIG. 3C is partial cross-sectional view taken along line segment 3C-3C, according to an embodiment of the present invention;

FIG. 4A is a partial cross-sectional view of the lock assembly shown in FIG. 2, with the lock assembly shown in an unlocked configuration, according to an embodiment of the present invention;

FIG. 4B is rear end view of the lock assembly shown in FIG. 4A, according to an embodiment of the present invention; and

FIG. 4C is partial cross-sectional view taken along line segment 4C-4C, according to an embodiment of the present invention.

### DETAILED DESCRIPTION OF EMBODIMENTS OF THE PRESENT INVENTION

Various embodiments of the present invention will now be described in detail with reference to the accompanying drawings. In the following description, specific details such as detailed configuration and components are merely provided to assist in the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

As used herein, the term “distal” refers to a portion of the receiver lock that is being described which is further from a user, while the term “proximal” refers to a portion of the receiver lock that is being described which is closer to a user.

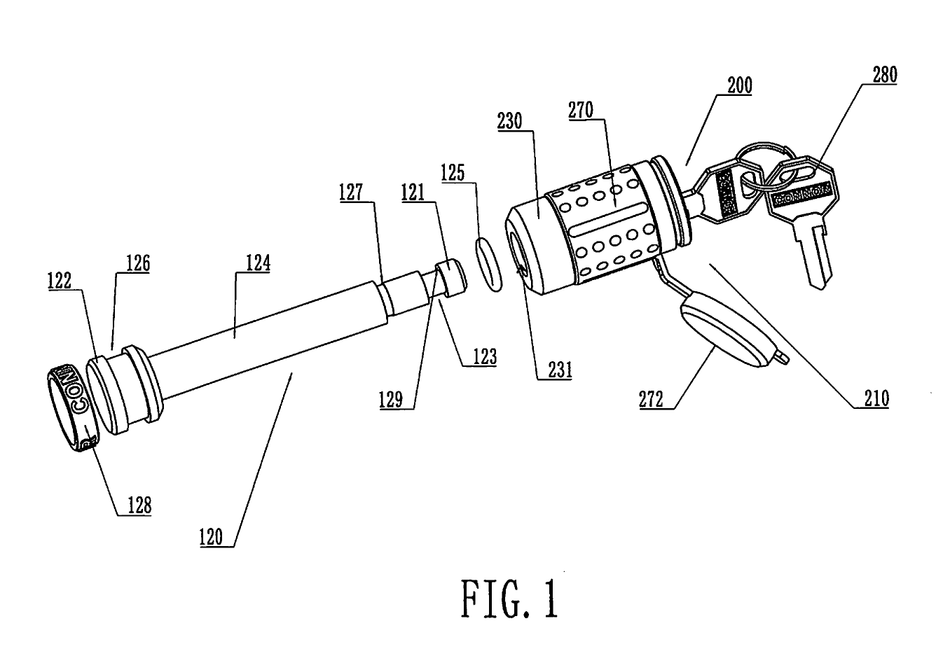

FIG. 1 is a perspective view of a receiver lock 200 including a lock assembly 210 and lock rod 120, which are shown separated, according to an embodiment of the present invention. The receiver lock 100 is configured to connect an accessory insert (not shown) within a receiver of a vehicle hitch assembly (also not shown). The receiver and accessory insert include apertures that are alignable when the accessory insert is positioned within the receiver.

The lock rod 120 is circular in cross section and has a generally elongated configuration. The lock rod 120 includes a proximal portion 122 and a distal portion 124. The proximal portion 122 has a diameter that is larger than a diameter of the distal portion 124. The distal portion 124 has a length and diameter that is configured to allow a user to insert the distal portion 124 through the aligned apertures of the accessory insert and the receiver, while the diameter of the proximal portion 122 is configured to prevent the proximal portion 122 from passing through the aligned apertures of the accessory insert and the receiver.

The proximal portion 122 includes an annular recess 126 which has seated therein a rubber gripping surface 128 that is configured to facilitate gripping of the proximal portion 122.

Alternatively, the proximal portion 122 can be provided without the rubber gripping surface 128, in which case the annular recess 126 can be omitted.

The distal portion 124 includes a distal end 121 and an annular groove 123 that is positioned adjacent the distal end 121. The distal end 121 and annular groove 123 are insertable into the lock assembly 120, as will be described below.

An O-ring 125 of suitable configuration is seated within an annular recess 127, which is provided proximal to the annular groove 123, and is configured to form a seal between the lock rod 120 and the lock assembly 110 when the lock rod 120 and lock assembly 110 are in a locked configuration, as will be described below. Alternatively, the O-ring 125 can be replaced by a gasket or other suitable structure, or distal portion 124 may be provided without the O-ring 125.

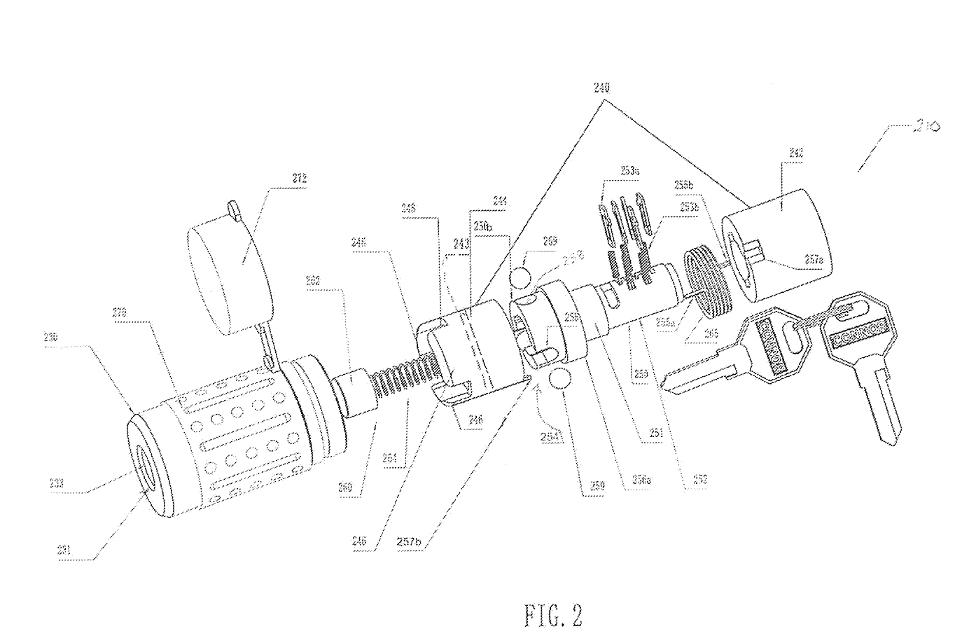

The lock housing 230 houses the internal components of the lock assembly 210. The lock housing 230 is coupled, via one or more suitable coupling methods, to a case 240 which is connected by suitable methods to a cylinder 250 (the case 240 and cylinder 250 are shown FIG. 2). In the assembled configuration, the cylinder 250 is rotatable with respect to both the lock housing 230 and the case 240 when a key 280 is inserted into the cylinder 250 and turned, e.g., for locking and unlocking the lock rod 120 to and from the lock assembly 210.

The lock housing 230 includes an opening 231 of suitable configuration that is configured to receive the distal end 121 including the annular groove 123 of the lock rod 120. The lock housing 230 also includes an annular recess (not shown) that has positioned therein a gripping surface 270 that is configured to facilitate gripping of the lock housing 230.

An optional cap 272 may be tethered to the gripping surface 270 and may be used to cover a proximal end of the lock housing 230 including the cylinder 250 when the key 280 is not inserted in cylinder 250 to protect the internal components of the lock housing 230.

FIG. 2 is a perspective view of the lock assembly 210, with parts separated, according to an embodiment of the present invention. Unlike convention lock assemblies, the lock assembly 210 uses an automatic locking mechanism and an automatic ejection mechanism for locking and unlocking the lock rod 120 to/from the lock assembly 210, operation of which will be described in greater detail below.

Continuing with reference to FIG. 2, the lock assembly 210 includes the case 240, which is shown unassembled in FIG. 2, the cylinder 250, a spring assembly 260, and a return spring 265. The case 240, the cylinder 250, the spring assembly 260, and the return spring 265 work in conjunction with each other to form the automatic locking mechanism and the automatic ejection mechanism, in accordance with the present invention.

The cylinder 250 includes a body portion 252 and a head portion 254. The body portion 252 includes a plurality of locking pins 253a and a corresponding plurality of locking pin springs 253b which, when the key 280 is inserted into a key hole located at a proximal end of the body portion 252, work in conjunction to allow the cylinder 250 to move from a locked configuration to an unlocked configuration. Unlike conventional lock assemblies which use a key to move the cylinder between locked and unlocked configurations, the key 280 is not needed to move the cylinder 250 into the locked configuration, as such an operation is performed automatically upon insertion of the lock rod 120 into the lock housing 230, as will be described in greater detail below.

The return spring 265 is supported on a distal end 251 of the body portion 252 and includes proximal and distal end portions 255a and 255b that are connected, via openings (not shown), to the distal end 251 and a proximal end 242 of the case 240. The return spring 265 moves the cylinder 250 to the locked configuration when the lock rod 120 is inserted into the lock housing 230, as described in greater detail below.

The head portion 254 includes proximal and distal ends 256a and 256b, respectively, which have a generally cylindrical configuration. The proximal end 256a includes a diameter that is slightly greater than a diameter of the distal end 256b and is configured to contact an interior circumferential wall 243 (shown in phantom in FIG. 2) located on a distal end 244 of the case 240 when the lock assembly 210 is in an assembled configuration; this contact properly aligns the distal end 256b of the head portion 254 with the distal end 244 of the case 240.

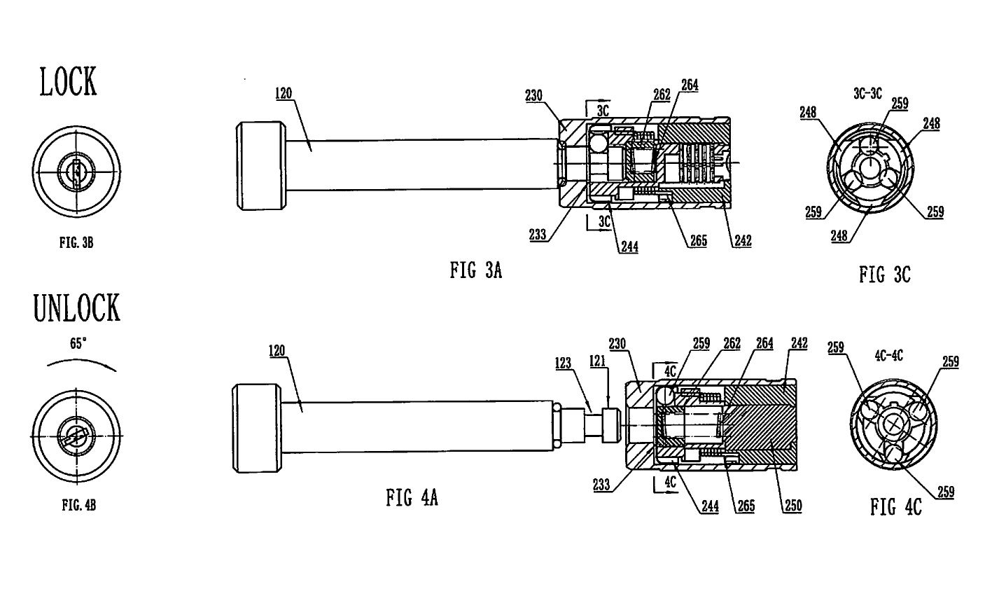

The distal end 256b includes three apertures 258 (or grooves) that have seated therein three corresponding ball bearings 259, which are movable within the apertures 258 when the cylinder 250 is moved between the locked and unlocked configurations. More particularly, when the cylinder 250 is in the locked configuration, the ball bearings 259 project radially inwards, and when the cylinder 250 is in the unlocked configuration, the ball bearings 259 project radially outwards (see FIGS. 3C and 4C, respectively, for example).

While three apertures 258 and ball bearings 259 are shown in FIG. 2, more or less than three of each of these components can be used. For example, the distal end 256b can include one aperture 258 and one corresponding ball bearing 259.

The distal end 256b of the head portion 254 includes a generally cylindrical cavity that houses the spring assembly 260. The spring assembly 260 includes a spring head 262 and a spring 264. The spring head 262 is coupled to the spring 264 via one or more suitable coupling methods. For example, the spring head 262 may have a cavity that is configured to receive a distal end of the spring 264, or the spring head 262 may be directly connected, via soldering or adhesive, for example, to the spring 264. Regardless of how the spring head 262 and spring 264 are connected, the force of the spring 264 urges the spring head 262 distally away from the cavity of the distal end 256b of the head portion 254. A proximal end of the spring 264 may be secured within the cavity of the distal end 256b.

The spring head 262 is translatable within the lock assembly 210 with respect to the cylinder 250 and the lock housing 230 from a first configuration, wherein the spring head 262 contacts an interior wall 233 of the lock housing 230, thereby projecting the ball bearings 259 radially outward, to a second configuration, wherein the spring head 262 is positioned within the cavity of the distal end 256b, i.e., proximally relative to the ball bearings 259, which will be projected radially inwards, as a result of being in contact with the case 240, as will be described in greater detail below.

The case 240 includes the proximal end 242 and the distal end 244. The proximal end 242 and the distal end 244 are coupled to each other via an indent 257a that is located on the proximal end 242 and a detent 257b that is located on the distal end 244. However, other coupling methods are contemplated.

The proximal end 242 supports the cylinder 250 so that the cylinder 250 may rotate about the proximal end 242 when the cylinder 250 is moved between the locked and unlocked configurations.

The distal end 244 includes an opening that allows the spring head 262 to translate through the distal end 244 when the cylinder 250 is moved between the locked and unlocked configurations. To ensure that the spring head 262 translates along a relatively straight line through the distal end 244, an optional channel (not shown) may be defined through the distal end 244 and a corresponding protrusion or detent (not shown) that translates within the channel may be provided on the spring head 262.

The distal end 244 includes three spaced-apart walls 246 that are separated by three grooves 248. The three spaced-apart walls 246 are configured to contact a corresponding one of the ball bearings 259 when the cylinder 250 is in the locked configuration, and the three grooves 248 are configured to receive a corresponding one of the ball bearings 259 when the cylinder is in the unlocked configuration. As can be appreciated, more or less than three of each of the three spaced-apart walls 246 or grooves 248 can be provided.

It is noted that the ball bearings 259 are able to move between the positions of being projected radially outward and radially inward as a result of the distal end 256b of the head portion 254 being aligned with the distal end 244 of the case 240.

Operation of the receiver lock 200 is described with reference to FIGS. 3A-4C.

With the lock rod 120 locked to the lock assembly 210, when the cylinder 250 is moved to the unlocked configuration, e.g., the cylinder 250 is moved approximately sixty five degrees in a clockwise direction along an axis of rotation of the cylinder 250 (see FIG. 3B in conjunction with FIG. 4B), the ball bearings 259 of the head portion 254 are moved into alignment with the grooves 248 of the distal end 244 of the case 240 (FIGS. 4A and 4C). Also, when the cylinder 250 is moved to the unlocked configuration, the spring head 262 of the spring assembly 260 is forced distally, under the bias provided by the spring 264, into contact with the interior wall 233 of the lock housing 230. When the spring head 262 is in this position, the spring head 262 contacts each of the ball bearings 259 and projects each of the ball bearings 259 radially outward and into each of the corresponding grooves 248 (FIGS. 4A and 4C). With the ball bearings 250 in their respective grooves 248, a user can insert the lock rod 120 into the lock housing 230.

In accordance, with the instant invention, the force provided by the spring 264 to move the spring head 262 distally also allows the spring head 162 to automatically eject the lock rod 120 out from the lock housing 230, thereby facilitating removal of the lock rod 120 from the lock housing 230.

To lock the lock rod 120 to the lock assembly 210, a user inserts the distal end 121 including the annular groove 123 into the opening 231 of the lock housing 230. When the distal end 121 contacts the spring head 262, continued inward force applied by the user overcomes the force exerted on the spring head 262 by the spring 264 and allows the user to push the spring head 262 back into the cavity of the distal end 256b of the head portion 254, i.e., to a position that is proximal relative to the ball bearings 259. Once the spring head 262 is no longer in contact with the ball bearings 259, the return spring 265 automatically rotates the cylinder 250 including the head portion 254 back to the locked configuration (FIGS. 3B and 3C), i.e., sixty five degrees in a counterclockwise direction (see FIG. 4B in conjunction with FIG. 3B).

Rotating the head portion 254 back to the locked configuration aligns each of the ball bearings 259 with each of the corresponding walls 246 of the distal end 244 of the case 240. In this position, each of the ball bearings 259 are projected radially inward, via contact with each of the corresponding walls 246, into the annular groove 123 of the lock rod 120, thereby locking the lock rod 120 to the lock assembly 210 (FIGS. 3A and 3C).

Unlike conventional receiver locks that require a key to lock a lock rod to a lock assembly, the receiver lock 200 does not require a key to perform such a function. Moreover, conventional receiver locks do not provide a mechanism that automatically ejects a lock rod from a lock assembly when an unlocking operation of the receiver lock is performed.

In accordance with the present invention, the components of the receiver lock 200 can be formed from any material including, but not limited to, metal, metal alloy, plastic, plastic composites, etc.

While the present invention has been particularly shown and described with reference to certain embodiments thereof, it will be understood by those of ordinary skill in the art that various changes in form and details may be made therein without departing from the spirit and scope of the present invention as defined by the following claims and their equivalents.

What is claimed is:

1. A receiver lock configured to lockingly connect an accessory insert within a receiver of a vehicle hitch assembly, the receiver and accessory insert including alignable apertures, the receiver lock comprising:
a lock rod having a distal portion configured to extend through the aligned apertures of the insert and accessory receiver to prevent removal of the insert from the accessory receiver, the distal portion including an annular groove adjacent a distal end of the distal portion; and
a lock assembly including a lock housing configured to receive the distal portion of the lock rod such that reception of the distal portion within the lock housing triggers a lock mechanism of the lock housing to automatically engage the annular groove of the distal portion for locking the lock rod to the lock assembly.

2. The receiver lock according to claim 1, wherein the lock mechanism comprises:
a case including a proximal end and a distal end;
a cylinder rotatably supported within the case and movable from an unlocked configuration to a locked configuration; and
a spring including a spring head that is moveable relative to the case and at least partially housed within the cylinder.

3. The receiver lock according to claim 3, wherein the distal end of the case includes three spaced-apart walls that are separated by three grooves.

4. The receiver lock according to claim 3, wherein the cylinder includes a body portion and a head portion.

5. The receiver lock according to claim 4, wherein the body portion of the cylinder is configured to receive a key, which, when inserted into the body portion, is configured to rotate the cylinder with respect to the case from the locked configuration to the unlocked configuration, and the head portion of the cylinder includes at least one ball bearing that is movable with respect to the distal end of the case as the cylinder is rotated with respect to the case.

6. The receiver lock according to claim 5, wherein the head portion houses three ball bearings.

7. The receiver lock according to claim 5, wherein, with the lock rod locked to the lock assembly, rotation of the cylinder from the locked configuration to the unlocked configuration moves the spring head distally and into contact with a distal wall portion of the lock housing, thereby projecting the at least one ball bearing radially outward into at least one of the three grooves of the distal end of the case and automatically ejecting the lock rod from the lock assembly.

8. The receiver lock according to claim 5, wherein, with the cylinder in the unlocked configuration, insertion of the distal end of the lock rod into the lock assembly, moves the spring head proximally against the bias of the spring and out of contact with the distal wall portion of the lock housing and rotates the cylinder such that the at least one ball bearing aligns with at least one of the three spaced-apart walls of the distal end of the case, thereby projecting the at least one ball bearing radially inward into the annular groove of the lock rod.

9. The receiver lock according to claim 2, wherein the lock mechanism further comprises a return spring that is coupled to the proximal end of the case and the body portion of the cylinder, the return spring biased to move the cylinder from the unlocked configuration to the locked configuration when the lock rod is inserted into the lock assembly.

10. A lock assembly configured to detachably mount to a lock rod configured to lockingly connect an accessory insert within a receiver of a vehicle hitch assembly, the receiver and accessory insert including alignable apertures, the lock assembly comprising:
a lock housing configured to receive a distal portion of the lock rod such that reception of the distal portion within the lock housing triggers a lock mechanism of the lock housing to automatically engage an annular groove of the distal portion for locking the lock rod to the lock assembly.

11. The lock assembly according to claim 10, wherein the lock mechanism comprises:
a case including a proximal end and a distal end;
a cylinder rotatably supported within the case and movable from an unlocked configuration to a locked configuration; and
a spring including a spring head that is moveable relative to the case and at least partially housed within the cylinder.

12. The lock assembly according to claim 11, wherein the distal end of the case includes three spaced-apart walls that are separated by three grooves.

13. The lock assembly according to claim 12, wherein the cylinder includes a body portion and a head portion.

14. The lock assembly according to claim 13, wherein the body portion of the cylinder is configured to receive a key, which, when inserted into the body portion, is configured to rotate the cylinder with respect to the case from the locked configuration to the unlocked configuration, and the head portion of the cylinder includes at least one ball bearing that is movable with respect to the distal end of the case as the cylinder is rotated with respect to the case.

15. The lock assembly according to claim 14, wherein the head portion houses three ball bearings.

16. The lock assembly according to claim 14, wherein, with the lock rod locked to the lock assembly, rotation of the cylinder from the locked configuration to the unlocked configuration moves the spring head distally and into contact with a distal wall portion of the lock housing, thereby projecting the at least one ball bearing radially outward into at least one of the three grooves of the distal end of the case and automatically ejecting the lock rod from the lock assembly.

17. The lock assembly according to claim 14, wherein, with the cylinder in the unlocked configuration, insertion of the distal end of the lock rod into the lock assembly, moves the spring head proximally against the bias of the spring and out of contact with the distal wall portion of the lock housing and rotates the cylinder such that the at least one ball bearing aligns with at least one of the three spaced-apart walls of the distal end of the case, thereby projecting the at least one ball bearing radially inward into the annular groove of the lock rod.

18. The lock assembly according to claim 11, wherein the lock mechanism further comprises a return spring that is coupled to the proximal end of the case and the body portion of the cylinder, the return spring biased to move the cylinder from the unlocked configuration to the locked configuration when the lock rod is inserted into the lock assembly.

19. A receiver lock configured to lockingly connect an accessory insert within a receiver of a vehicle hitch assembly, the receiver and accessory insert including alignable apertures, the receiver lock comprising:
a lock rod having a distal portion configured to extend through the aligned apertures of the insert and accessory receiver to prevent removal of the insert from the accessory receiver;
and
a lock assembly including a lock housing,
wherein insertion of the distal portion of the lock rod into the lock housing moves a spring head of the lock assembly proximally against a bias of a spring thereby moving a cylinder of the lock assembly from an unlocked configuration for receiving the distal portion of the lock rod to a locked configuration for automatically locking the lock rod to the lock assembly.

20. The receiver lock according to claim 19, wherein the distal portion includes an annular groove that is adjacent a distal end of the distal portion, the annular groove configured to engage at least one ball bearing of the lock assembly when the cylinder is moved into the locked configuration.

21. A lock assembly configured to detachably mount to a lock rod configured to lockingly connect an accessory insert within a receiver of a vehicle hitch assembly, the receiver and accessory insert including alignable apertures, the lock assembly comprising:
a lock housing; and
a cylinder,
wherein insertion of a distal portion of the lock rod into the lock housing moves a spring head of the lock assembly proximally against a bias of a spring thereby moving the cylinder of the lock assembly from an unlocked configuration for receiving the distal portion of the lock rod to a locked configuration for automatically locking the lock rod to the lock assembly.

22. A receiver lock configured to lockingly connect an accessory insert within a receiver of a vehicle hitch assembly, the receiver and accessory insert including alignable apertures, the receiver lock comprising:
a lock rod having a distal portion configured to extend through the aligned apertures of the insert and accessory receiver to prevent removal of the insert from the accessory receiver; and
a lock assembly including a lock housing,
wherein, with the lock rod locked to the lock housing, rotation of a cylinder of the lock assembly releases a spring head of the lock assembly such that the spring head is urged distally under a force provided by spring connected to the spring head thereby automatically ejecting the lock rod from the lock assembly.

23. A lock assembly configured to detachably mount to a lock rod configured to lockingly connect an accessory insert within a receiver of a vehicle hitch assembly, the receiver and accessory insert including alignable apertures, the lock assembly comprising:
a lock housing; and
a cylinder,
wherein, with the lock rod locked to the lock housing, rotation of a cylinder of the lock assembly releases a spring head of the lock assembly such that the spring head is urged distally under a force provided by spring connected to the spring head thereby automatically ejecting the lock rod from the lock assembly.
